(19) United States
(12) Patent Application Publication
(10) Pub. No.: US 2011/0045279 A1
(43) Pub. Date: Feb. 24, 2011

(54) MOLDED BODY HAVING POROUS SURFACE AND METHOD FOR THE PRODUCTION THEREOF

(76) Inventors: Roland Heinl, Marktredwitz (DE); Karl-Heinz Ley, Marktredwitz (DE); Peter Schröter, Wunsiedel (DE); Peter Schricker, Marktredwitz (DE)

Correspondence Address: FULBRIGHT & JAWORSKI, LLP, 666 FIFTH AVE, NEW YORK, NY, 10103-3198, US

(21) Appl. No.: 12/990,067

(22) PCT Filed: Apr. 27, 2009
(86) PCT No.: PCT/EP09/55056

§ 371 Date: Oct. 28, 2010

Related U.S. Application Data
(63) Continuation of application No. 61/125,810, filed on Apr. 28, 2008.

(30) Foreign Application Priority Data
Apr. 28, 2008 (DE) 10 2008 001 402.8

(51) Int. Cl. B32B 5/18; B32B 18/00; B28B 5/00

(52) U.S. Cl. 428/318.6; 264/241

(57) ABSTRACT

A ceramic formed piece with porous surface and a method for the production of same.

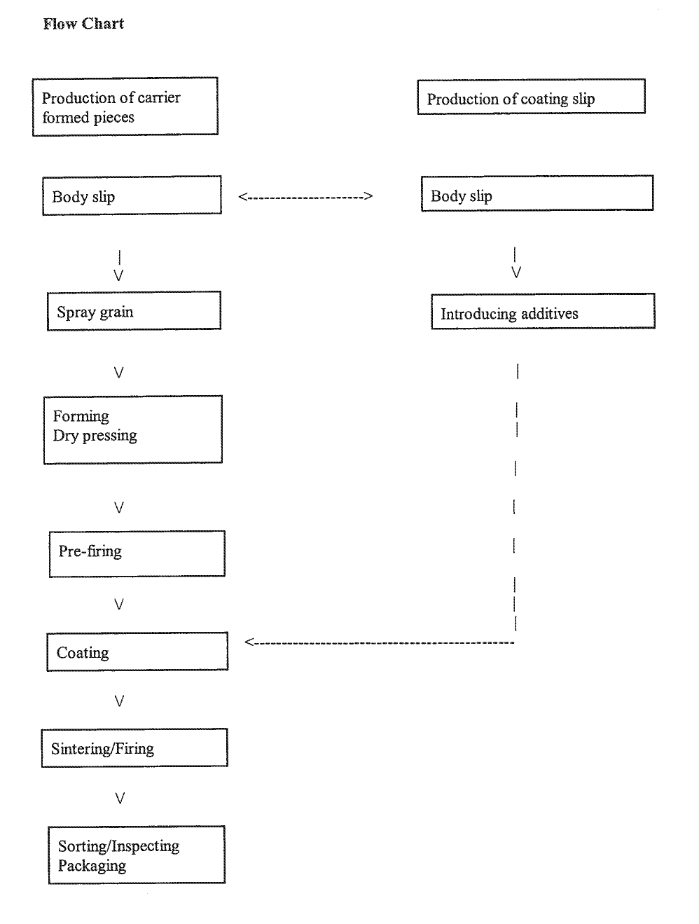

The invention relates to a ceramic formed piece with a porous surface and a method for its production.

Formed pieces with porous surfaces are suitable in particular as carriers for, active agents in order to immobilize these.

By applying the active agents onto such carriers, the mechanical properties (for example strength durability) of the active agents can also be improved.

As said agents are considered inter alia such substances that accelerate or decelerate chemical reactions without themselves being consumed in the chemical reaction. They are also referred to as accelerators or as inhibitors. An accelerator (inhibitor) decreases (increases) the activation energy required for a chemical reaction such that a chemical reaction proceeds faster (slower) at a given temperature. In the chemical industry primarily utilized are accelerators. Many chemical reactions are only possible at all through the simultaneous use of an accelerator or inhibitor since without the accelerator the chemical reaction would proceed extremely slowly or since, at the temperature necessary for the reaction, without inhibitors the thermodynamic equilibrium lies on the side of the starting materials. Since accelerators and inhibitors emerge substantially unchanged from the total reaction, they can pass through several reaction cycles while the starting materials are broken down and the products are synthesized.

Due to their inert behavior toward most agents and reactants, ceramic materials are in particular suitable as materials for carrier formed pieces.

In the case of multi-element oxide accelerators inter alia carrier formed pieces of silicate ceramic have been found to be useful, in particular such based on magnesium silicate.

If the latter contain soapstone as their main starting material, they are also referred to as steatite (a steatite advantageous according to the invention is Steatit C 220).

The multi-element oxide accelerators (for example multi-metal oxide accelerators) are typically applied onto the carrier formed piece in the form of layers. The accelerators immobilized in this manner can subsequently be utilized, for example in order to accelerate reactions of fluid substance mixtures that flow through them.

It is understood that the carrier formed piece can also be impregnated with the multi-element oxide accelerator (and subsequently be dried) in order to immobilize it. Instead of multi-element oxide accelerators, other agents, such as for example enzymes as accelerators, can also be immobilized on carrier formed pieces.

Of disadvantage in the known carrier formed pieces of ceramic materials is that the adhesive capacity of agents on their surface is not fully satisfactory.

The invention therefore addresses the problem of providing a ceramic formed piece with improved adhesive capacity for agents (in particular for multi-element oxide accelerators) and thereby, lastly, also to improve the effectiveness (i.e. selectivity and activity) of the agents applied thereon as the carrier.

The problem is solved through a ceramic formed piece with porous surface, characterized in that the ceramic formed piece is comprised of a ceramic formed base body and a porous ceramic shell applied thereon, the porous ceramic shell being sintered jointly with the ceramic base body, and the ceramic material of the base body as well as the ceramic material of the porous ceramic shell are selected from the group comprising silicate ceramics and metal oxide ceramics and the two ceramic materials can be identical as well as also different from one another. As examples of such silicate ceramics are listed steatite (main component=magnesium silicate), zirconium silicate and aluminum silicate (for example mullite). Examples of such metal oxide ceramics are aluminum oxide, magnesium oxide and zirconium oxide.

Advantageous embodiments of the invention are claimed in the dependent claims.

Basis of the solution to the problem is the fact that the adhesive capacity of an agent (of an accelerator or an inhibitor) on a carrier formed piece is significantly improved if its surface is porous and, preferably, is additionally rough. A formed piece with such a surface property can, according to the invention, be developed thereby that onto a ceramic formed base body a porous shell of a ceramic material is applied.

In principle, the porous shell can herein be comprised of another ceramic material than the formed-base body. It is, however, advantageous if the ceramic material of the formed base body and the ceramic material of the porous shell are the same. Thereby conformance of the chemical and physical properties of base body and shell are attained. For example, both have the same thermal coefficient of expansion. Thereby an unequal thermal expansion of base body and shell is avoided which, for example, can possibly lead to the spalling of the shell.

The choice of the ceramic material depends on the agent to be immobilized as well as the chemical reaction whose speed is to be affected.

In the case of multi-element oxides as agents and partial oxidations of organic compounds as the reactions to be accelerated, such ceramic materials have been found to be advantageous for the carrier formed pieces to be utilized that are distinguished by a total content of alkali metals of maximally 2 wt. %, preferably of maximally 1 wt. %, a total alkaline earths content not comprising magnesium of not more than 2 wt. % (herein in particular a barium content of less than 0.5 wt. %, preferably less than 0.05 wt. %) and a low iron content of maximally 1.5 wt. %, preferably less than 1 wt. %. The above low contents, as a rule, promote activity and selectivity of the multi-element oxide accelerator.

The application of the porous shell onto the formed base body can appropriately take place using implementation techniques such that in a rotating coating drum formed base body precursors are sprayed with a coating slip, produced from a ceramic body slip with the addition of additives, and subsequently dried and sintered.

The additives comprise in particular a pore-forming agent that is driven out during the sintering process and leaves pores of the desired degree in the applied shell. The porosity, and with it also the roughness, of the ceramic shell can be set via the added quantity and the particle size of the added pore-forming agent. Preferred are pore-forming agents that can be driven out without leaving residues in order for the pores to be completely available for the application and for anchoring the agents to be immobilized. Examples of pore-forming agents are potato starch, ground nutshells, corn starch and synthetic granulates (for example of polyethylene).

In order to obtain an especially rough and, concomitant therewith, large surface of the porous shell applied onto the formed base body, it is advantageous if the utilized pore-forming agent leads to an open-pored structure of the shell. An open-pored structure of the ceramic shell functions like a sponge. A large surface is formed and thereby a large area is made available for the application and adhesion of the accelerating or retarding agent (for example multi-element oxides).

The open pore structure of the shell of the carrier formed piece brings about a capillary action which has an advantageous effect on the application of the agents as well as on their actions on reactive fluids (for example reaction gas mixtures of fluids). Through the capillary action reactive fluids whose reaction time is to be affected are absorbed by the agent coating as by a sponge.

The increase, due to the pores, of the subsequently active agent surface of the agent coating applied onto the carrier formed piece, as a rule, also gives rise to increased activity of the agent layer.

The thickness of the porous ceramic shell of the carrier formed piece according to the invention in terms of application techniques is advantageously in the range from 0.05 mm to 0.5 mm, preferably in the range from 0.1 mm to 0.3 mm. As a rule, the fraction of pores per unit volume of the porous ceramic shell is 20 to 65 vol. %, preferably 30 to 40 vol. %, for example 35 vol. %.

The number median diameter d50 of the pores of the ceramic shell is advantageously 1 μm to 10 μm, preferably 4 μm to 6 μm. The porous ceramic shell of the ceramic carrier formed piece according to the invention cannot fulfill its task of improving the adhesion of the active agents if it is too thin. On the other hand, porous shells that are too thick or porosities that are too high lower the mechanical permanence of the porous layer and thus increase the risk of spalling of the porous shell.

The ceramic formed base body bearing the porous ceramic shell, in contrast, should be of high mechanical strength. For that reason, it has advantageously a dense structure. As a rule, the formed base body is free of pores or has, at best, a low pore fraction that is normally below 10 vol. %.

The remaining additives for the production of the coating slip are primarily auxiliary agents used for improving the spray properties of the slip, for increasing the adhesive capacity and strength of the applied layer, for stabilizing/preserving the slip and for preventing the formation of foam.

The production of a ceramic carrier formed piece according to the invention with porous shell will be described in further detail in the following.

In a manner known per se, first, the production of a green formed base body takes place.

From an aqueous body slip leading to the considered ceramic material, which slip comprises in a manner known per se the fine-particle mixture, required for the formation of the ceramic material, of the mineral raw starting substances (ceramic raw substances) as well as, as a rule, additives such as for example liquifiers (for example TARGON® 94 (a polycarboxylate)), defoaming agents (for example Contraspum® (higher alcohol)) and binding agents (for example cellulose), by spray-drying in a spray tower is obtained a pressable granulate (the aqueous body slip is also referred to as spray slip). This spray grain is preferably pressed by dry pressing into a green formed base body whose geometry depends on its intended later use. Frequently utilized geometries are spheres and rings (whose largest dimension is typically 2 to 14 mm). The median grain size (d50, mass) in the aqueous body slip in terms of application technique is usefully 0.5 μm to 20 μm (the corresponding median grain diameter d50, mass in the aqueous coating slip is in terms of application technique usefully 0.5 to 50 μm).

After the press molding a basic firing of the green formed base bodies is carried out at temperatures substantially below the sinter temperatures required for the production of the considered ceramic material (for example steatite). The preliminary firing frequently (for example in the case of the considered material Steatit C220) takes place at 600 to 1000° C., often at 700 to 800° C. In this manner a formed base body precursor is produced which has the mechanical stability necessary for the further handling in the application of the coating slip.

The pre-fired formed base body precursor, which, however, is not yet dense and completely sintered in its core, has an absorptive capacity still sufficient (favorable) for the subsequent coating process, which capacity has an advantageous effect when the coating slip is sprayed on.

As already stated, coating of the formed base body precursor takes place with an aqueous coating slip whose mineral raw material composition according to the invention advantageously corresponds to the aqueous body slip (spray slip) utilized for the production of the formed base body precursor. If for the porous shell the same mineral grain size as for the formed base body is considered, for the production of the aqueous coating slip suitable in terms of application techniques the aqueous body slip utilized for the production of the formed base body precursor will be taken as the basis.

For a different grain size the slip for generating the porous shell must be mixed separately. Applying the coating slip onto the surface of the formed base body precursor can, in principle, be carried out using different methods depending on the intended thickness of the resulting porous shell. The viscosity required for this purpose is set by adding appropriate additives. The coating can be carried out, for example, by immersion, spraying-on or in a coating drum.

Before the application onto the formed base body precursor said pore-forming agents are added to the aqueous coating slip. Their grain size depends primarily on the size of the desired pores. In the case of pore builders, which additionally inflate during their decomposition, the volume increase of the pores compared to the grain size of the pore-forming agent must be taken into account. The shrinkage of the resulting ceramic upon cooling after the sintering must simultaneously be taken into consideration, which shrinkage again reduces the pore size.

After the coating of the formed base body precursor (after fragments have optionally been removed by screening) finishing the carrier formed piece takes place through a sintering method, matched to the resulting ceramic material, in a sinter furnace, the temperatures to be applied being normally in the range of 1250° C. to 1400° C. depending on the ceramic material under consideration.

In the case of Steatit C220 the sintering temperature will typically be 1300 to 1350° C.

Sintering times are typically in the range from 0.5 hrs to 8 hrs. Low temperatures require longer holding times to ensure diffusion, which is required for the sintering mechanism.

During the sintering process and the temporary debindering the temperature is controlled such that the binding agent and the pore-forming agent escape from the forming ceramic material without leaving residues and without therein an effect onto the formed body, for example inflation, being exerted through the developing decomposition products, in particular gases. As a result a ceramic carrier formed piece is obtained, which is comprised of a ceramic formed base body with a ceramic shell applied thereon.

The carrier formed pieces (in particular those of Steatit C220) obtained as described are in particular suitable for the immobilization of multi-element oxide agents.

They are primarily suitable for the application purposes, in particular those implemented in each case by example, disclosed for ceramic carrier formed pieces in the publications EP-A 1029591, U.S. Pat. No. 6,344,568, U.S. Pat. No. 6,780,816, U.S. Pat. No. 6,638,890, EP-A 1106246, DE-A 3826220, DE-A 4442346, DE-A 2135620, U.S. Pat. No. 6,288,273, EP-A 0966324, EP-A 1670575, US-A 2007/41795, WO 2005/030388, DE-A 10360058 as well as DE-A 10360057.

To clarify the method sequence in the production of ceramic carrier formed pieces according to the invention this document includes a corresponding flow chart.

In conjunction with the following embodiment examples 1 to 5 the invention will be explained again without therein limiting it an any manner. The chemical compositions, remaining after the firing, of the mineral raw materials utilized therein (stated as mass % relative to the particular total mass in the unfired state) are shown in Table 1 of this document. The firing loss listed in Table 1 is largely formed by water vapor.

TABLE 1

| | Al₂O₃ | SiO₂ | Fe₂O₃ | TiO₂ | CaO | MgO | Na₂O | K₂O | Firing Loss |
|---|---|---|---|---|---|---|---|---|---|
| Clay 1 | 33.6 | 47.9 | 1.8 | 2.2 | 0.7 | 0.1 | <0.1 | <0.1 | 13.5 |
| Clay 2 | 25.3 | 60.9 | 1.4 | 1.3 | 0.3 | 0.4 | 0.1 | 2.6 | 7.7 |
| Kaolin 1 | 37.4 | 47 | 0.8 | 0.2 | 0.3 | 0.1 | 0.1 | 0.8 | 13.3 |
| Bentonite 1 | 19.4 | 60.3 | 5.6 | 0.4 | 1.8 | 4.3 | 0.2 | 1.5 | 5.1 |
| Soapstone 1 | 0.8 | 61.7 | 0.9 | <0.1 | 0.1 | 31.4 | <0.1 | <0.1 | 5.1 |
| Talc powder 1 | 1 | 62 | 1 | <0.1 | 0.1 | 30 | 0.1 | <0.1 | 5.8 |
| Feldspar 1 | 17.6 | 66.8 | <0.1 | 0.1 | <0.1 | <0.1 | 0.6 | 14.6 | 0.2 |
| Feldspar 2 | 17.4 | 71.7 | 0.2 | <0.1 | 1.2 | 0.1 | 7.3 | 1.8 | 0.2 |
| Mg(OH)₂ | — | — | — | — | — | 69 | — | — | 30.8 |

### EXAMPLES 1 TO 5

The compositions of the aqueous body slip (without consideration of added organic additives) utilized within the scope of the production of the particular green formed base body are compiled in Table 2 (all data in mass % relative to the total mass).

TABLE 2

| | Example 1 | Example 2 | Example 3 | Example 4 | Example 5 |
|---|---|---|---|---|---|
| Clay 1 | — | — | 2.6 | — | 2.8 |
| Clay 2 | 2.8 | — | 2.2 | 5 | — |
| Kaolin 1 | 2.8 | 5.7 | — | — | 3.7 |
| Bentonite 1 | — | 0.5 | 0.5 | — | — |
| Soapstone 1 | — | 58.7 | 58.3 | 60.3 | — |
| Talc power 1 | 58.7 | — | — | — | 60.5 |
| Feldspar 1 | 1.7 | — | 2.7 | 2.7 | 3.2 |
| Feldspar 2 | 2.4 | 3.6 | — | — | — |
| Mg(OH)₂ | 1 | — | 1.4 | 1 | — |
| Water | 30.6 | 31.5 | 32.3 | 31 | 29.8 |

Grinding to form the aqueous body slip in all embodiment examples is carried out by means of a ball mill. In each case the grinding time was determined such that each yielded a median grain size (d50, mass[%]) of 12 μm.

As additives were added to the aqueous body slip from Table 2 (referred to their initial mass): 0.3 mass % TARGON® 94 (liquifier based on a polycarboxylate), 0.1 mass % Contraspum® (defoaming agent based on higher alcohols) and 0.1 mass % cellulose (as binding agent).

If needed, preservation agents (for example Dilurit®) can additionally be added, as well as optionally suspending agents to prevent sedimentation of the mineral particles.

Each of the aqueous body slips (or spray slips) were spray-dried and the spray grain resulting therefrom having a median grain size d50, mass of 0.3 mm, was dry-pressed in a press to form an annular body. The green formed base body resulting therein had an annular geometry O (outer diameter=8 mm)×I (inner diameter=4.7 mm)×H (height=3.5 mm). Alternatively, a ring geometry of O (7 mm)×I (4 mm)×H (3 mm) can also be chosen.

The obtained green formed base bodies were pre-fired under air in a sintering furnace as follows: heating within 25 minutes from ambient temperature to 760° C.; the temperature of 760° C. was maintained for 10 minutes and subsequently cooling within 15 minutes to ambient temperature took place.

Due to the described pre-firing, the resulting formed base body precursor acquires the firmness required for the application of the aqueous coating slip. However, it is not yet sintered through, i.e. at said temperatures no dense sintering occurs yet. However, all organic components that had been added as additives to the aqueous body slip undergo decomposition and are driven out of the material.

Thereby a formed base body precursor results which has an adequate up-take capacity for the aqueous coating slip.

Starting from the particular aqueous body slip (for this reason an appropriate subquantity (not yet including any additives) is separated from the same) utilized for the coating of the formed base body precursor obtained as described above, the aqueous coating slip utilized for the coating of the formed base body precursor, obtained as described above, is produced.

For this purpose to the aqueous body slips of Examples 1 and 5, relative to the mass of their inorganic solid content, were added 15 mass % polyethylene (=pore-forming agent; median grain size d50, mass=30 μm) and 4 mass % polyvinyl alcohol (MOWIOL® 4/88=further binding agent).

The MOWIOL addition was in the form of a 17 wt. % aqueous solution, which contained an added 0.2 mass % conc. Contraspum®. In addition, 5 to 10 mass % (relative to the body slip) of water were added as a suspension means. A further additive was formed by 0.1 mass % Dilurit (relative to the body slip). The aqueous coating slips 1 and 5 were herein obtained.

For the same purpose, to the aqueous body slips of Examples 2, 3 and 4, relative to the mass of their inorganic solid content, were added 20 mass % corn starch by Cerestar of Type RG 03453 (=pore-forming agent; median grain size d50, mass=15 μm) and 5 mass % polyvinyl alcohol (MOWIOL® 4/88=further binding agent). MOWIOL was added as a 17 wt. % aqueous solution which contained an added 0.2 mass % of conc. Contraspum®. In addition, 5 to 10 mass % (relative to the body slip) of water were added as suspension means. A further additive was 0.1 mass % of Dilurit (relative to the body slip). The aqueous coating slips 2, 3, and 4 were herein obtained.

Application of the aqueous coating slips thus obtained onto the formed base body precursor having the same example number (via a roller screen with mesh width 6 mm×6 mm at 1.5 mm wire thickness, dust and fragments were separated from the same before their coating) was carried out in a coating drum (oblique plate, Eirich, 50 rmp).

This coating drum was filled with approximately 32 kg of the annular formed base body precursors and during the rotation with a stationarily disposed spray device over 7 minutes 2 liters of the associated aqueous coating slip was sprayed in through nozzles (the liter weight of the particular aqueous coating slip was 1340 to 1360 g/l; the outflow time was 20 to 25 seconds).

The drum was subsequently emptied and the coated rings were guided via a further roller screen (mesh width 5.7 mm×5.7 mm, wire thickness 1.5 mm) to remove dust and fragments. The layer thickness in the dried state was approximately 0.1 mm.

The coated formed base body precursors were subsequently sintered in a tunnel furnace under air.

The sintering took place at a heating rate of 80° C./hr until a temperature of 1330° C. was reached. This temperature was maintained for 1.5 hours and subsequently brought down at a rate of 150° C./hr. Obtained were thus annular ceramic carrier formed base bodies with porous ceramic shell.

The porosity of the resulting shells was approximately 35 vol. %, the number median pore channel diameter d50 was approximately 5 μm measured by means of mercury pressure porosimetry. The form of the developed pore structures resembled a bottle. The pore channel diameter corresponded to the diameter of the bottle neck, the grain size of the pore-forming agent corresponded to the diameter of the bottle body.

Such backward-extending structures are advantageous for toothing effects. The pores were open, whereby the porous shell acquired a sponge-like structure. Such a pore structure offers optimal conditions for the application of the multi-element oxide agents disclosed in EP-A 1029591, U.S. Pat. No. 6,344,568, U.S. Pat. No. 6,780,816, U.S. Pat. No. 6,638,890, EP-A 1106246, DE-A 03826220, DE-A 4442346, DE-A 2135620, U.S. Pat. No. 6,288,273, EP-A 0966324, EP-A 1670575, US-A 2007/41795, WO 2005/030388, DE-A 10360058 and DE-A 10360057 and form the preconditions that no spalling of the applied multi-element oxide active agent occurs any longer during the partial oxidations accelerated by means of the multi-element oxides immobilized in such manner of said documents.

The ring geometry O (7 mm)×I (4 mm)×H (3 mm) of all Examples 1 to 5 is suitable in particular as a porous coated carrier formed base body for use in all embodiment examples of documents DE-A 04442346, DE-A 10360058 and DE-A 10360057, as well as for realizing the entire teaching provided in these documents. This also applies to the ceramic formed pieces claimed in the present document. Improved selectivities of the target product formation are obtained. This applies in particular to the partial oxidation of propenal to propenoic acid (on carrier formed pieces bearing multi-element oxide agents comprising Mo and V).

### Comparison Example 1

The annular green formed base body of Example 4 was heated as such in the geometry O (7 mm)×I (4 mm)×H (3 mm) in a tunnel furnace at a heating rate of 80° C. [/hr] to a temperature of 1330° C. and held at this temperature for 1.5 hrs as well as subsequently cooled at a cooling rate of 150° C./hr. A dense ring was formed which was utilized as such in the embodiment examples of DE-A 04442346 as carrier formed piece.

When utilizing the thus immobilized multi-element oxide as an accelerator for the partial oxidation conducted by example in DE-A 04442346, adhesion problems of the multi-element oxide mass on the carrier formed piece were observed and, as a consequence, spalling occurred, and resulting therefrom local accumulations bringing about increased pressure loss.

1-18. (canceled)

19. A ceramic formed piece with a porous surface, comprising a ceramic material comprising
a ceramic formed base body comprising a ceramic material;
a porous ceramic shell comprising a further ceramic material, wherein the porous ceramic shell is applied on the base body, and wherein the porous ceramic shell is sintered together with the ceramic base body and the ceramic material of the base body and the ceramic material of the porous ceramic shell are selected from the group consisting of a silicate ceramic and a metal oxide ceramic, wherein the ceramic material of the base body and the further ceramic material of the porous ceramic shell can be identical as well as also different from one another.

20. A ceramic formed piece as claimed in claim 19, wherein its Fe content is ≦1.5 wt. %.

21. A ceramic formed piece as claimed in claim 19, wherein its total content of alkaline earth metals, differing from magnesium, is ≦2 wt. %.

22. A ceramic formed piece as claimed in claim 19, wherein its Ba content is ≦0.5 wt. %

23. A ceramic formed piece as claimed in claim 19, wherein the mineral composition of the material of the ceramic formed base body agrees with the mineral composition of the material of the porous shell.

24. A ceramic formed piece as claimed in claim 19, wherein the shell thickness is 0.05 mm to 0.5 mm.

25. A ceramic formed piece as claimed in claim 19, wherein the material of the ceramic formed base body has a porosity of ≦10 vol. %.

26. A ceramic formed piece as claimed in claim 19, wherein the porous shell has a porosity of 20 to 65 vol. %.

27. A ceramic formed piece as claimed in claim 19, wherein the number median pore diameter d₅₀ of the porous shell is 1 μm to 10 μm.

28. A ceramic formed piece as claimed in claim 19, wherein the porous shell has an open pore structure with sponge character.

29. A ceramic formed piece as claimed in claim 19, wherein the median grain size d_{50, mass} of the mineral components of the aqueous body slip utilized for the production of the formed base body is 0.5 μm to 20 μm.

30. A ceramic formed piece as claimed in claim 19, wherein the median grain size d_{50, mass} of the mineral components of the aqueous coating slip utilized for the production of the porous shell is 0.5 μm to 50 μm.

31. A ceramic formed piece as claimed in claim 19, wherein the ceramic materials are selected from the group consisting of steatite, aluminum silicate, zirconium silicate, aluminum oxide, magnesium oxide and zirconium oxide.

32. A method for the production of a ceramic formed piece having a porous shell comprising the steps of mixing an aqueous basic suspension of mineral raw materials of silicate ceramics mixed, spray-drying the form a spray granulate;
pressing the spray granulate in a mold to form a green formed base body;
pre-firing the green formed base body at a temperature of from 600° C. to 1000° C. to drive out any organic components to a base body precursor, wherein the same mineral raw materials are mixed, and an organic pore-forming agent is added to the aqueous suspension before coating the formed base body precursor, and wherein after coating the coated base body precursor is sintered at temperatures of 1250° C. to 1400° C. to form the ceramic formed piece with porous ceramic shell.

33. A method as claimed in claim 32, wherein the sinter time is 0.5 to 8 hours.

34. A method as claimed in claim 32, wherein the heating rate to the sinter temperature is 80° C./hr.

35. A method as claimed in claim 32, wherein the base body precursor is coated by immersion, spraying or coating in a coating drum.

36. A method as claimed in claim 32, wherein the ceramic formed piece comprises a member selected from the group consisting of steatite, aluminum silicate, zirconium silicate, aluminum oxide, magnesium oxide and zirconium oxide.
